(19) United States
(12) Patent Application Publication
(10) Pub. No.: US 2022/0331721 A1
(43) Pub. Date: Oct. 20, 2022

(54) FLUID FILTER AND METHOD OF USE OF SAME

(71) Applicant: KMOBATEVA POOLS OF NATURE LTD, Tel-Aviv (IL)

(72) Inventors: Arnon TAL, Kibbuta Lehavat Chaviva (IL); Amir TAL, Netany (IL)

(73) Assignee: KMOBATEVA POOLS OF NATURE LTD, Tel-Aviv (IL)

(21) Appl. No.: 17/639,392

(22) PCT Filed: Aug. 31, 2020
(86) PCT No.: PCT/IL2020/050948

§ 371 Date: Mar. 1, 2022

(30) Foreign Application Priority Data
Sep. 1, 2019 (IL) 269055

(51) Int. Cl. B01D 33/048; B01D 33/80; B01D 33/50; C02F 1/00

(52) U.S. Cl. CPC B01D 33/048; B01D 33/801; B01D 33/50; C02F 1/004; C02F 2103/42

(57) ABSTRACT

A fluid filter device and method of using the same are disclosed. The filter device may include a casing including a first face, a second face and at least one lateral face positioned between the first face and the second face and perpendicular thereto. The filter device may include at least two elongated pulleys rotatably supported within the casing between the first face and the second face of the casing. The filter device may include a filtering mesh threaded on at least some of the elongated pulleys to define an interior of the filtering mesh. The elongated pulleys and locations thereof within the casing are adapted to arrange the filtering mesh into a predetermined shape and to enable rotation of the filtering mesh about the at least some of the elongated pulleys.

### FIELD OF THE INVENTION

The present invention relates to the field of fluid filters, and more particularly, to physical fluid filters.

### BACKGROUND OF THE INVENTION

Water pools (such as swimming pools, fishponds, etc.) typically require filtering systems adapted to remove residuals from the water. The residuals may, for example, include organic contaminates (e.g., leaves, bird droppings, flowers, fish waste, etc.) and non-organic contaminates (e.g., sand, plastic particles, etc.).

For example, some commercially available filtering systems typically include a housing with a filtering drum rotatably mounted therein. Filtering drums typically have cylindrical shape which may limit installation configurations thereof within the housing and/or limit an effective filtering area of the filtering drum that is available for filtering to no more than 60-70% of the entire surface are thereof. Furthermore, disassembling of such filtering systems (e.g., in the case of malfunction or maintenance procedures) is typically complex and time consuming.

### SUMMARY OF THE INVENTION

One aspect of the present invention provides a filter device. The filter device may include a casing including a first face, a second face and at least one lateral face positioned between the first face and the second face and perpendicular thereto; at least two elongated pulleys rotatably supported within the casing between the first face and the second face of the casing; and a filtering mesh threaded on at least some of the elongated pulleys to define an interior of the filtering mesh; wherein the elongated pulleys and locations thereof within the casing are adapted to arrange the filtering mesh into a predetermined shape and to enable rotation of the filtering mesh about the at least some of the elongated pulleys.

Another aspect of the present invention provides a filtering system. The filtering system may include a housing and the filtering device as described above removably mountable within the housing.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIGS. 1A, 1B, 1C, 1D and 1E are schematic illustrations of a filter device, according to some embodiments of the invention;

FIGS. 2A, 2B, 2C and 2D are schematic illustrations of a filtering system and a filter device, according to some embodiments of the invention;

FIGS. 3A, 3B, 3C and 3D are schematic illustrations of various configurations of a filter device, according to some embodiments of the invention;

FIG. 4A is a schematic illustration of a more detailed aspect of a filter device, according to some embodiments of the invention;

FIG. 4B is a schematic illustration of a more detailed aspect of a filtering mesh of a filter device, according to some embodiments of the invention; and

FIG. 4C is a schematic illustration of a more detailed aspect of a driving assembly of a filter device, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

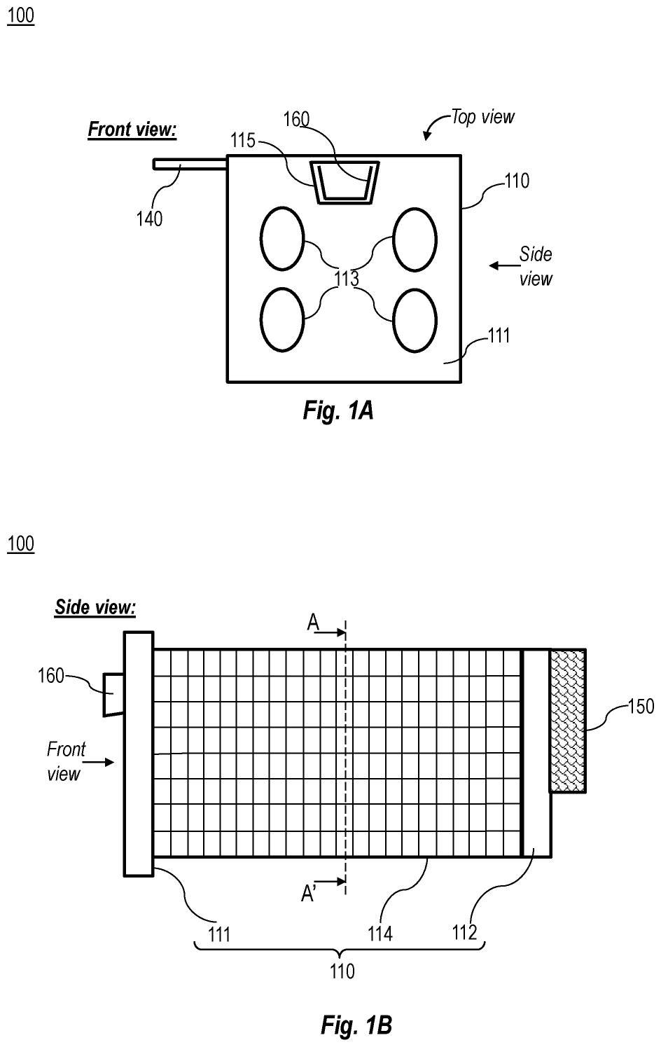

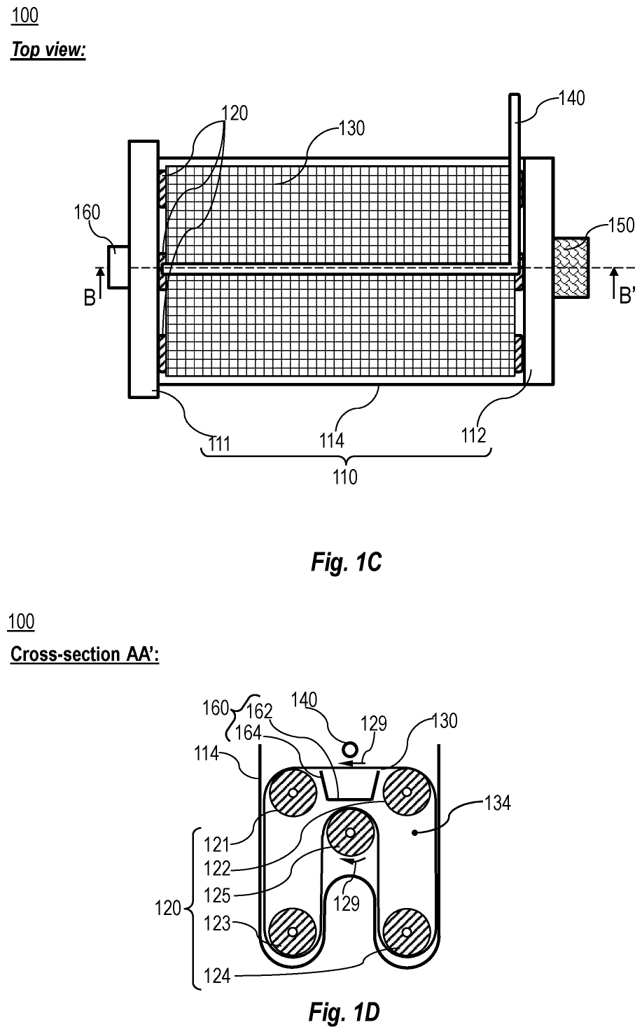

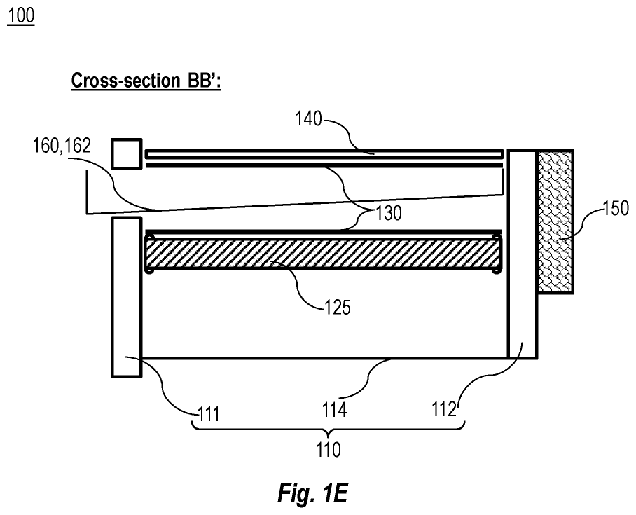

Reference is now made to FIGS. 1A, 1B, 1C, 1D and 1E, which are schematic illustrations of a filter device 100, according to some embodiments of the invention.

FIG. 1A shows a front view of filter device 100. FIG. 1B shows a side view of filter device 100. FIG. 1C shows a top view of water filter device 100. FIG. 1D shows a transverse cross-section AA′ (as defined in FIG. 1B) of filter device 100. FIG. 1E shows a longitudinal cross-section BB′ (as defined in FIG. 1C) of filter device 100.

According to some embodiments, filter device 100 may include a casing 110, at least two elongated pulleys 120, a filtering mesh 130, a rotating assembly 140, a washing tube 140 and a drainage channel 160.

According to some embodiments, casing 110 may include a first face 111, a second face 112 parallel to first face 111 and at least one lateral face 114 positioned between first face 111 and second face 112 and parallel thereto (e.g., as shown in FIG. 1B).

First face 111 may include at least one inlet opening 113. For example, first face 111 may include four inlet openings 113 (e.g., as shown in FIG. 1A). Lateral face(s) 114 may, for example, have a grid-like shape (e.g., as shown in FIG. 1B).

In some embodiments, first face 111 may further include a drainage channel opening 115 through which drainage channel 160 may extend external to casing 110 (e.g., as shown in FIGS. 1A and 1B). In some other embodiments, drainage channel opening 115 may be located on second face 112.

According to some embodiments, pulleys 120 may be rotatably supported within casing 110 between first face 111 and second face 112 of casing 110 (e.g., as shown in FIG. 1B). Filtering mesh 130 may be threaded on, or suspended/stretched over, pulley(s) 120 and/or may envelope at least some of pulleys 120 along the entire length (or substantially along the entire length) of pulleys 120 (e.g., as shown in FIGS. 1C and 1D). Pulleys 120 and/or predetermined locations of pulleys 120 within casing 110, may define a shape of filtering mesh 130 (e.g., as shown in FIG. 1D). Pulleys 120 may be adapted to enable rotation of filtering mesh 130 about pulleys 120 (e.g., as indicated by arrows 129 in FIG. 1D). Outer ends of filtering mesh 130 may form (e.g., when filtering mesh is threaded on pulleys(s) 120) a predetermined mesh curve along which filtering mesh 130 may move when pulley(s) 120 rotate.

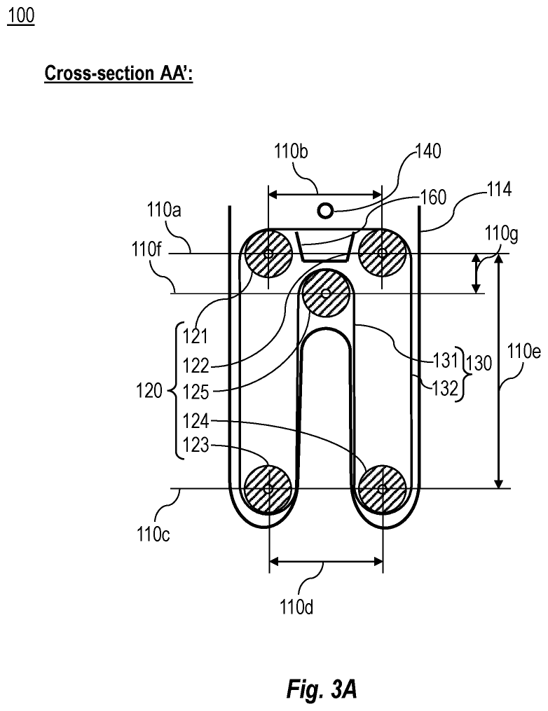

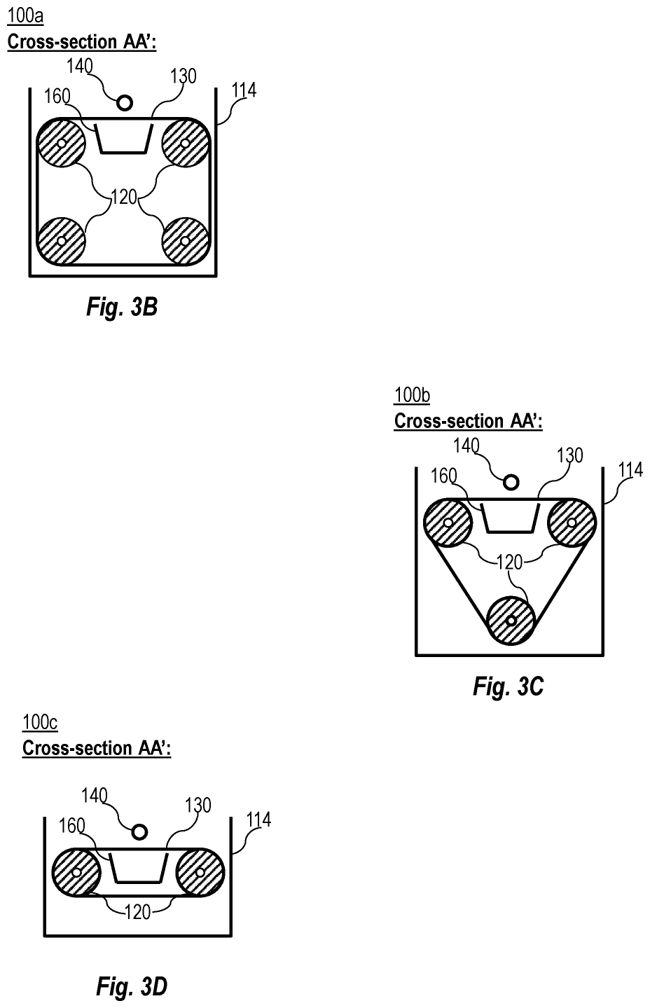

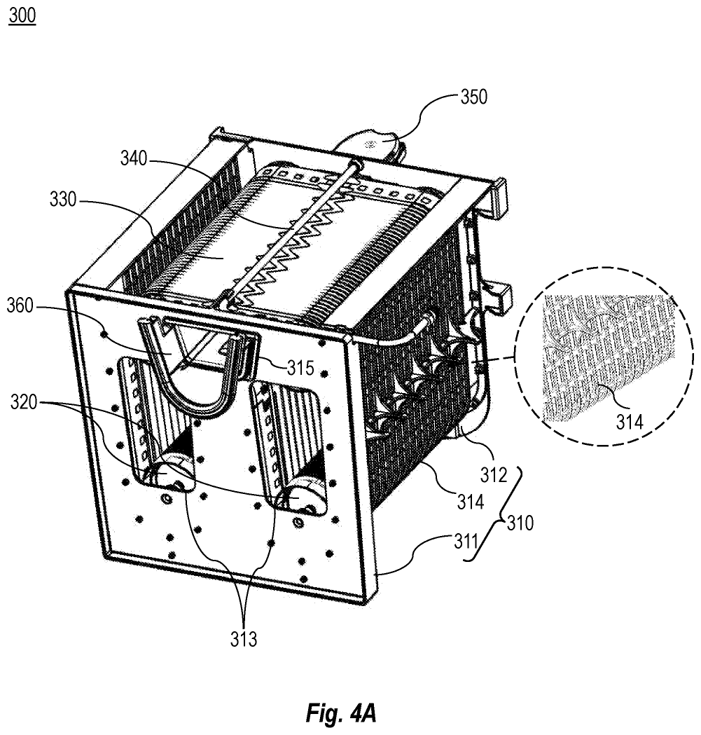

For example, filter device 100 may include five pulleys 120—a first pulley 121, a second pulley 122, a third pulley 123, a fourth pulley 124 and a fifth pulley 125 (e.g., as shown in FIG. 1D). Yet in this example, pulleys 120 are located within casing 110 to arrange filtering mesh 130 into a substantially W shape (e.g., as shown in FIG. 1D and as described below with respect to FIG. 3A). Yet in this example, the outer ends of filtering mesh 130 may form a substantially W shape mesh curve (e.g., when filtering mesh 130 is threaded on pulleys(s) 120) along which filtering mesh 130 may move when pulleys(s) 120 rotate.

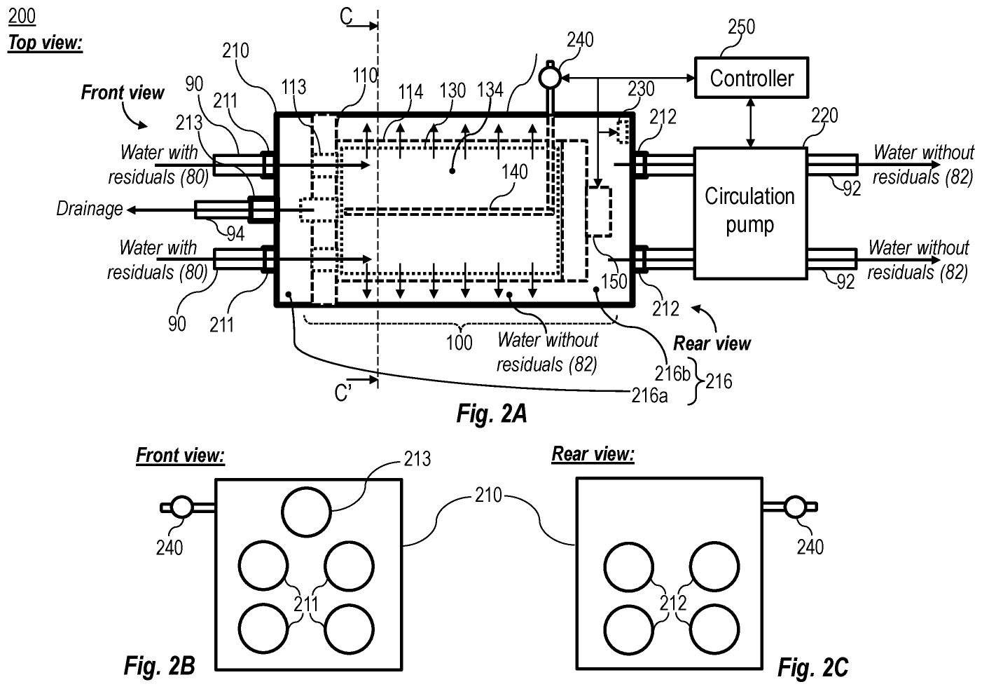

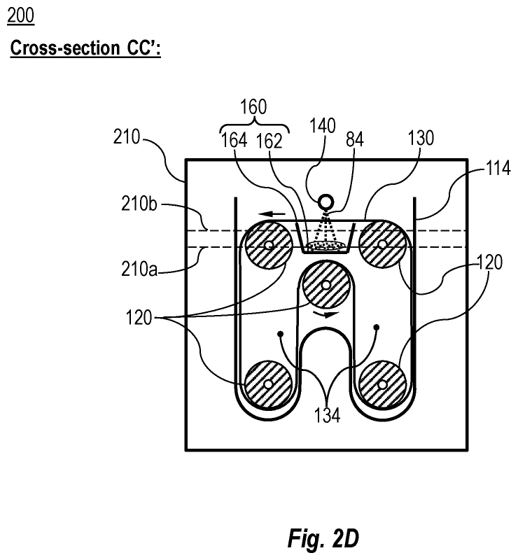

Filtering mesh 130, arranged into a predetermined shape by pulleys 120, may have an interior 134 (e.g., as shown in FIG. 1D). Interior 134 of filtering mesh 130 may be adapted to receive water with residuals through inlet opening(s) 113 of casing 110 when filter device 100 operates within a filtering system (e.g., as described below with respect to FIGS. 2A, 2B, 2C and 2D). In various embodiments, the shape and/or dimensions of inlet opening(s) 113 may be predetermined based on the predetermined shape of filtering mesh 130 to maximize the flowrate of water into interior 134 of filtering mesh 130. For example, for the W-shape of filtering mesh 130 (e.g., as shown in FIG. 1D), inlet opening(s) 130 may have substantially elliptic shape (e.g., as shown in FIG. 1A). Filtering mesh 130 may be adapted to remove residuals from water when the water flows therethrough (e.g., as described below with respect to FIGS. 2A, 2B, 2C and 2D).

It is noted that filter device 100 may have other number of pulleys 120 that may be adapted to arrange filtering mesh 130 into variety of different shapes. In general, a number of pulleys 120 and/or the predetermined shape of filtering mesh 130 may be predetermined according to an application of filter device 100 and/or according to application of a filtering system in which filtering device 100 is designed to operate (e.g., as described below with respect to FIGS. 2A, 2B, 2C and 2D). The number of pulleys 120 and/or the predetermined shape of filtering mesh 130 may be further predetermined to maximize a portion of filtering mesh 130 that may be submerged under water when filter device 100 operates within a filtering system, thus to maximize an effective filtering area of filtering mesh 130 available for removal of residuals from water (e.g., as described below with respect to FIGS. 2A, 2B, 2C and 2D). In some embodiments, the number of pulleys 120, the locations of pulleys 120 in casing 110 and the shape of filtering mesh 130 are determined to ensure that at least 80% of filtering mesh 130 is submerged under water when filter device operates within a filtering system (e.g., as described below with respect to FIG. 3A).

In some embodiments, shape and/or dimensions of lateral face(s) 114 of casing 110 may correspond to the shape and/or dimensions of filtering mesh 130 as defined by pulleys 120. Lateral face(s) 114 of casing 110 may be adapted to support filtering mesh 130 while enabling rotation of filtering mesh 130 about pulleys 120. For example, lateral face(s) 114 of casing 110 may have substantially W-shape that corresponds to the W-shape of filtering mesh 130 (e.g., as shown in FIG. 1D). Grid-like lateral face(s) 114 of casing 110 may enable free flow of water from interior 134 of filtering mesh 130 external thereto (e.g., when filter device 100 operates in a filtering system) through filtering mesh 130 and lateral face(s) 114.

According to some embodiments, washing tube 140 may be mounted within casing 110 and external to interior 134 of filtering mesh 130. Washing tube 140 may be mounted substantially adjacent to filtering mesh 130. Washing tube 140 may extend along the entire length of casing 110 (e.g., as shown in FIGS. 1D and 1E). Washing tube 140 may include injection apertures facing filtering mesh 130 through which washing water may be injected onto filtering mesh 130 to thereby clean filtering mesh 130.

In general, washing tube 140 may be adapted to provide a desired flowrate and pressure to the washing water that are high enough to remove residuals accumulated in filtering mesh 130 when the washing water is injected thereon. In some embodiments, washing tube 140 may be adapted to provide the desired flowrate and pressure to the washing water that is supplied thereto directly from a water supply system (such as municipal water supply system).

For example, washing tube 140 may be mounted substantially adjacent to filtering mesh 130 such that a distance between washing tube 140 and filtering mesh 130 may be no more that 1-3 cm. A diameter of washing tube 140 may, for example, range between 0.8-1.2 cm. Injection apertures may, for example, have circular shape or may be shaped as elongated slots. A diameter of the injection apertures (or the short dimension of the slots) in washing tube 140 may, for example, range between 0.05-0.2 cm. A distance between adjacent injection apertures on washing tube 140 may, for example, range between 0.5-2 cm.

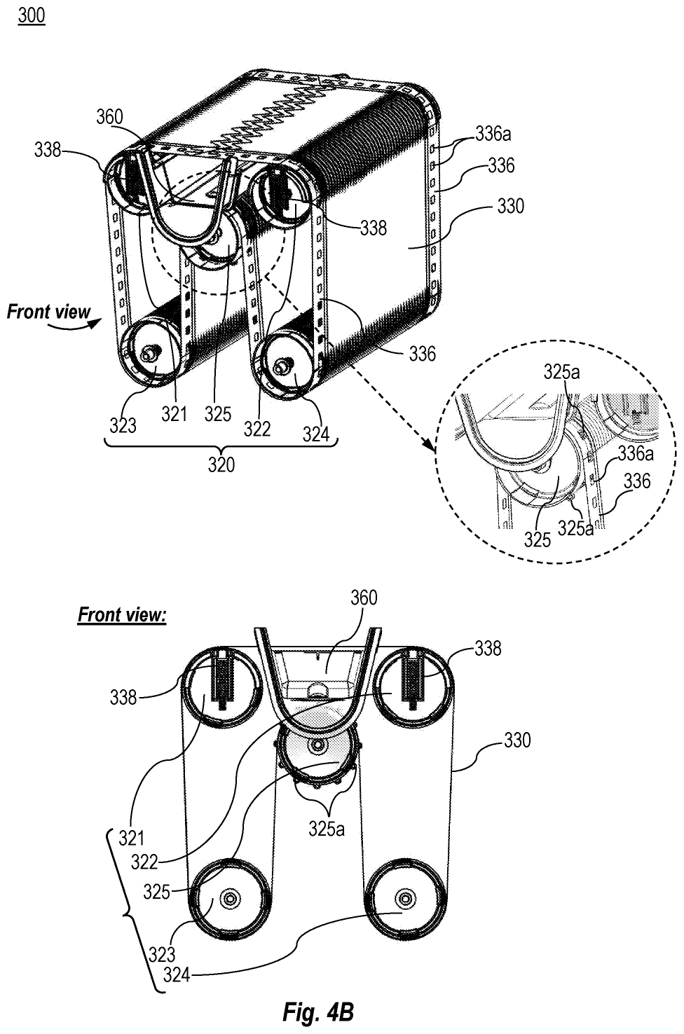

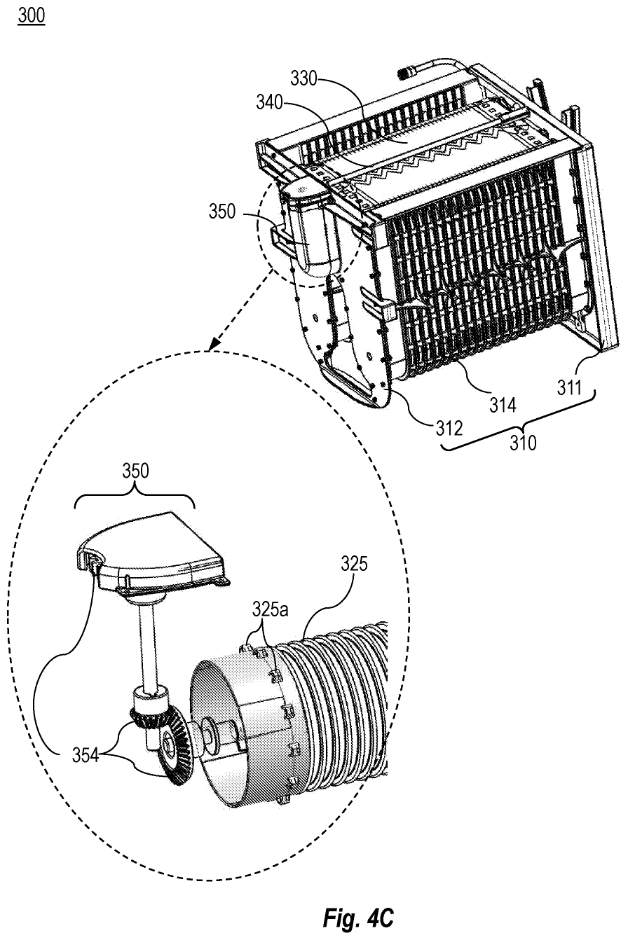

According to some embodiments, driving assembly 150 may be adapted to rotate one of pulleys 120 to thereby drive and rotate filtering mesh 130 about pulleys 120. Driving assembly 150 may be attached to casing 110 and external thereto. Driving assembly 150 may be attached to, for example, second face 112 (e.g., as shown in FIGS. 1B, 1C and 1E) or first face 111 (not shown) of casing 110. Driving assembly 150 may include a rotational motor coupled to one of pulleys 120 via one or more gears to thereby transmit rotations generated by the rotational motor to the pulley (e.g., as described below with respect to FIG. 4C). For example, driving assembly 150 may be coupled to fifth pulley 125, which may be adapted to rotate filtering mesh 130 about first pulley 121, second pulley 122, third pulley 123 and fourth pulley 124 (e.g., as indicated by arrows 129 in FIG. 1D).

According to some embodiments, drainage channel 160 may be mounted within interior 134 of filtering mesh 130. Drainage channel 160 may extend along the entire length of casing 110 between second face 112 and first face 111 and/or may extend external to casing 110 via drainage channel opening 115 on, for example, first face 111 (e.g., as shown in FIG. 1E). Drainage channel 160 may be adapted to collect water and/or residuals cleaned from filtering mesh 130 by cleaning water jetted from washing tube 140.

The location of drainage channel 160 within casing 110 may limit the submerging of filter mesh 130 under water when filter device 100 operates within a filtering system, as at least a portion of lateral faces 164 of drainage channel 160 should remain under the water level. In some embodiments, drainage channel 160 may be mounted within interior 134 of filtering mesh 130 substantially adjacent to filtering mesh 130. For example, a distance between filtering mesh 130 and a base face 162 of drainage channel 160 may be no more than 4-8 cm. In this manner, the portion of filtering mesh 130 that may be submerged under water when filter device 100 operates within a filtering system may be maximized, thus maximizing the effective filtering area of filtering mesh 130.

In some embodiments, drainage channel 160 may be sloped. For example, in embodiments shown in FIG. 1E, drainage channel 160 may be sloped in a direction extending between second face 112 and first 111 of casing 110. The slope may facilitate drainage of the collected water and/or residuals by drainage channel 160 external to casing 110.

According to some embodiments, filter device 100 may be removably mountable within a housing of a filtering system (e.g., as described below with respect to FIGS. 2A, 2B, 2C and 2D). For example, in the case of malfunction or as a part of routine maintenance procedures, filter device 100 may be easily removed and replaced with another filter device 100, thus eliminating a need in complex and time-consuming disassembling procedures typically required in current filtering systems.

Reference is now made to FIGS. 2A, 2B, 2C and 2D, which are schematic illustrations of a filtering system 200 and a filter device 100, according to some embodiments of the invention.

FIG. 2A shows a top view of filtering system 200 with filter device 100 (indicated by dashed lines) removably mounted therein. FIGS. 2B and 2C show front view and rear view of filtering system 200, respectively. FIG. 2D shows transverse cross-section AA′ view (as defined in FIG. 2A) of filtering system 200.

According to some embodiments, filtering system 200 may include a housing 210, at least one circulation pump 220, at least one water level sensor 230, a washing tube valve 240, a controller 250 and a filter device 100 (e.g., filter device 100 described above with respect to FIGS. 1A, 1B, 1C, 1D and 1E). Filter device 100 may be removably mountable within housing 210.

Housing 210 may include at least one inlet pipe coupler 211, at least one outlet pipe coupler 212 and a drainage pipe coupler 213. In some embodiments, filter device 100, inlet pipe coupler(s) 211, outlet pipe coupler(s) 212 and drainage pipe coupler 213 may be part of a kit.

Inlet pipe coupler(s) 211 may be adapted to couple inlet pipe(s) 90 to housing 210 to thereby provide fluid communication between inlet pipe(s) 90 and interior 134 of filtering mesh 130 of filter device 100. In some embodiments, first face 111 of filter device 100 may mate the dimensions of an interior 216 of housing 210 thus forming a first interior chamber 216a and a second interior chamber 216b in housing 210 when filter device 100 is installed within housing 210 (e.g., as shown in FIG. 2A). In this manner, fluid communication between first interior chamber 216a and second interior chamber 216b may be through inlet opening 113 on first face 111 and through filtering mesh 130 of filter device 100.

Outlet pipe coupler(s) 212 may be adapted to couple outlet pipe(s) 92 to housing 210 to thereby provide fluid communication between interior 216 (e.g., second interior chamber 216b) of housing 210 and outlet pipe(s) 92. Circulation pump(s) 220 may be coupled to outlet pipe(s) 92 downstream the pipe(s) and adapted for circulating water between, for example, a water pool and filtering system 200.

Drainage coupler 213 may be adapted to couple drainage channel 160 of filter device 100 to a drainage pipe 94 to thereby provide fluid communication between drainage channel 160 and drainage pipe 94.

Housing 210 may be adapted to be filled with water. In some embodiments, a water level within housing 210 may range between a lower water level 210a and an upper water level 210b when filtering system 200 and filter device 100 operate under normal conditions (e.g., as shown in FIG. 2D). Upper water level 210b may be higher than lower water level 210a, for example, by 0.5 cm. The water level in housing 210 may depend on, for example, an amount of water in the water pool, amount of people in the water pool, etc. Water level sensor(s) 230 may be mounter within housing 210. Water level sensor(s) 230 may be adapted to measure the water level in housing 210 and to transmit the measured water level to controller 250.

Filter device 100 may be mounted within housing 210 such that most of filtering mesh 130 is submerged under the water when housing 210 is filled therewith. The submerging of filtering mesh 130 of filter device 100 may be limited by location of drainage channel 160 within casing 110 thereof. For example, at least a portion of lateral faces 164 of drainage channel 160, and thus at least a portion of filtering mesh 130, should be above the water level (e.g., as shown in FIG. 2D). In various embodiments, the locations of pulleys 120 within casing 110 of filter device 100 and/or the shape of filtering mesh 130 may be predetermined to ensure that at least 80% of filtering mesh 130 may be submerged under the water level in housing 210 when filter device 100 is mounted therein.

Washing tube valve 240 may be coupled to washing tube 140 of filter device 100 upstream the tube. Washing tube valve 240 may be adapted to control the passage of washing water therethrough.

Controller 250 may be in communication with filter device 100 (or at least driving assembly 150 of filter device 100), circulation pump(s) 220, water level sensor(s) 230 and washing tube valve 240. Controller 250 may be configured to control the operation of filter device 100 (or at least driving assembly 150 thereof), circulation pump(s) 220, water level sensor(s) 230 and washing tube valve 240.

The description below, yet made with respect to FIGS. 2A, 2B, 2C and 2D, describes an operation of filtering system 200 and of filter device 100 according to some embodiments of the invention.

Circulation pump(s) 220 of filtering system 200 may circulate water between, for example, a water pool (e.g., swimming pool, fishpond, etc.) and filtering system 200. Water with residuals 80 may be delivered from the water pool via inlet pipe(s) 90 and introduced into interior 134 of filtering mesh 130 of filter device 100 positioned within housing 210 of filtering system 200 through inlet pipe coupler(s) 211 and inlet opening(s) 113 of filter device 100.

When water with residuals 80 flows through filtering mesh 130 from interior 134 to interior 216 of housing 210, filtering mesh 130 may remove the residuals from water 80 such that water without residuals 82 may flow through grid-like lateral face(s) 114 of casing 110 of filter device 100 into interior 216 of housing 210. Filtering mesh 130 may be kept stationary most of the time and may be rotated about pulleys 120 only when cleaning of filtering mesh 130 is required.

Water without residuals 82 may fill housing 210. Water without residuals 82 may be removed from interior 216 of housing 210 via outlet pipe(s) 92 and delivered, for example, back to the water pool. The water level in housing 210 may range between lower water level 210a and upper water level 210b, depending on, for example, amount of water in the water pool and/or amount of people in the water pool. Water level sensor(s) 230 may be configured to measure the water level in housing 210 and transmit the measured water level to controller 250.

The residuals removed from water 80 may be accumulated within filtering mesh 130, thereby increasing a resistance of filtering mesh 130 to flow and reducing the flowrate of the water therethrough. Accordingly, the level of water within interior 216 of housing 210 may reduce since circulation pump(s) 220 may continuously pump water 82 from interior 216 of housing 210. A water level in interior 216 of housing 210 that is below a first predetermined water level threshold may indicate that cleaning/washing of filtering mesh 130 is required. For example, the first predetermined water level threshold may be few centimeters (e.g., 1-2 cm) below lower water level 210a.

Controller 250 may be configured to detect when the water level in interior 216 of housing 210 (e.g., measured by water level sensor(s) 240) reduces below the first predetermined water level threshold. Upon the detection thereof, controller 250 may be configured to activate driving assembly 150 of filter device 100 to initiate rotation of filtering mesh 130 about pulley 120. Simultaneously, controller 250 may be configured to open washing tube valve 240 to thereby introduce washing water 84 into washing tube 140 of filter device 100 and to inject washing water 84 onto rotating filtering mesh 130.

In various embodiments, controller 250 may turn off circulation pump(s) 220 for a predetermined period of time, when the level of water 82 within interior 216 of housing 210 reduces below the first predetermined water level threshold and/or when the rotation of filtering mesh 130 is initialized. When circulation pump(s) 220 are turned off, water without residuals 82 in interior 216 of housing 210 may perform a self-leveling with water with residuals 80 within interior 134 of filtering mesh 130 through filtering mesh 130. In this manner, the pressure within housing 210 is released to allow easier rotation of pulleys 120 (e.g., fifth pulley 125) and of filtering mash 130 by driving assembly 150. In this manner, mechanical loads acting on filter device 100 and/or housing 210 of filtering system 200 and/or power loads on filtering system 200 may be significantly as compared to case when circulation pump(s) 220 are not turned off. In some embodiments, the predetermined period of time may, for example, range between 20-30 sec. In some other embodiments, the predetermined period of time may be based on the rotational speed of filtering mesh 130 by driving assembly 150 and a length of a portion of filtering mesh that is below the water level.

Washing water 84 injected onto filtering mesh 130 may remove the residuals accumulated therein. The residuals removed from filtering mesh 130 may be collected by drainage channel 160 that further drains the residuals into drainage pipe 94 and external to filtering system 200.

In some embodiments, if the cleaning of filtering mesh 130 is not successful (e.g., due to malfunction in, for example, driving assembly 150 and/or washing tube 140 and/or washing tube valve 240), the level of water 82 within housing 210 may reduce below a second predetermined water level threshold. Controller 250 may be configured to detect when the water level in interior 216 of housing 210 (e.g., measured by water level sensor(s) 240) reduces below the second predetermined water level threshold. Upon the detection thereof, controller 250 may be configured to terminate the operation the elements of filtering system 200 and/or filter device 100 to prevent possible damage to the elements thereof.

Reference is also made to FIGS. 3A, 3B, 3C and 3D, which are schematic illustrations of various configurations of a filter device 100, 100a, 100b, 100c, according to some embodiments of the invention.

According to various embodiments, filtering device 100 may include various numbers of pulleys 120 rotatably supported within casing 110 and adapted to arrange filtering mesh 130 into variety of predetermined shapes. In general, the number of pulleys 120 and/or the shapes of filtering mesh 130 may be selected according to applications of filter device 100 and/or according to applications of filtering system (e.g., such as filtering system 200) in which filtering device 100 may operate. The number of pulleys 120 and/or the shapes of filtering mesh 130 may be further selected to, for example, maximize the portion of filtering mesh 130 submerged under the water when filter device 100 operates within a filtering system.

According some embodiments, filter device 100 may include five pulleys 120—first pulley 121, second pulley 122, third pulley 123, fourth pulley 124 and fifth pulley 125—that may be adapted to arrange filtering mesh 130 into a substantially W-shape structure when threaded thereon (e.g., as shown in FIG. 3A and as described above with respect to FIGS. 1A, 1B, 1C, 1D and 1E).

First pulley 121 and second pulley 122 may be positioned within casing 110 along a first transverse axis 110a and at a first transverse distance 110b with respect to each other. Third pulley 123 and fourth pulley 124 may be positioned along a second transverse axis 110c, at a second transverse distance 110d with respect to each other and at a first vertical distance 110e from first transverse axis 110a. Fifth pulley 125 may be positioned along a third transverse axis 110f and at a second vertical distance 110g from first transverse axis 110a. Fifth pulley 125 may be, for example, symmetrically positioned with respect first pulley 121 and second pulley 122 and with respect to third pulley 123 and fourth pulley 124 along third transverse axis 110f.

Filtering mesh 130 may be threaded on, or suspended/stretched over, pulleys 120 such that its internal face 131 is supported by first pulley 121, second pulley 122, third pulley 123, fourth pulley 124 and its external face 132 is supported by fifth pulley 125—thus arranging filtering mesh 130 into the substantially W shape.

First transverse distance 110b, second transverse distance 110c, first vertical distance 110e and/or second vertical distance 110g may be selected according to applications of filter device 100 and/or of filtering system 200 and/or in order to maximize the portion of filtering mesh 130 submerged under the water when filter device 100 is mounted and operates within a filtering system.

For example, in embodiments shown in FIG. 3A, first transverse distance 110b and second transverse distance 110c may have the same (or substantially the same value) while first vertical distance 110e may be about 1.5-folds larger than first transverse distance 110b and about 3-folds larger than second vertical distance 110g. In embodiments shown in FIG. 3A, at least 80% of filtering mesh 130 may be submerged below the water when filter device 100 operates within a filtering system.

According to various embodiments, filter device 100 may include any number of pulleys 120 that may be adapted to arrange filtering mesh 130 into variety of shapes. For example, FIG. 3B shows a filter device 100a (e.g., similar to filter device 100) that may include four pulleys 120 adapted to arrange filtering mesh 130 into a substantially rectangular shape. In another example, FIG. 3C shows a filter device 100b (e.g., similar to filter device 100) that may include three pulleys 120 adapted to arrange filtering mesh 130 into a substantially triangular shape. In another example, FIG. 3D shows a filter device 100c (e.g., similar to filter device 100) may include two pulleys 120 adapted to arrange filtering mesh 130 into a substantially linear shape (e.g., as shown in FIG. 3D).

It is noted that other configurations of filter device 100 with respect to the number of pulleys 120 and corresponding shapes of filtering mesh 130 are possible. In general, the number of pulleys 120 and corresponding shapes of filtering mesh 130 may be selected according to applications of filter device 100 and/or according to applications of filtering system and/or according to a required minimal portion of filtering mesh 130 to be submerged under the water when filter device 100 to be mounted and to operate within a filtering system.

Reference is now made to FIG. 4A, which is a schematic illustration of a more detailed aspect of a filter device 300, according to some embodiments of the invention.

Reference is also made to FIG. 4B, which is a schematic illustration of a more detailed aspect of a filtering mesh 330 of a filter device 300, according to some embodiments of the invention. FIG. 4B shows panoramic view and front view of filtering mesh 330.

Reference is also made to FIG. 4C, which is a schematic illustration of a more detailed aspect of a driving assembly 350 of a filter device 300, according to some embodiments of the invention.

According to some embodiments, filter device 300 may be similar to filter device 100 as described above with respect to FIGS. 1A, 1B, 1C, 1D and 1E and FIGS. 3A, 3B, 3C and 3D. Filter device 300 may be adapted to operate within a filtering system, such as filtering system 200, as described above with respect to FIGS. 2A, 2B, 2C and 2D.

According to some embodiments, filtering device 300 may include a casing 310, at least two elongated pulleys 320, a filtering mesh 330, a washing tube 340, a rotating assembly 350 and a drainage channel 360 (e.g., as show in FIG. 4A). Casing 310, pulleys 320, filtering mesh 330, washing tube 340, rotating assembly 350 and a drainage channel 360 may be similar to casing 110, pulleys 120, filtering mesh 130, washing tube 140, rotating assembly 150 and a drainage channel 160, respectively, as described above with respect to FIGS. 1A, 1B, 1C, 1D and 1E. Filtering mesh 330 may be also similar to filtering mesh 130 described above with respect to FIGS. 3A, 3B, 3C and 3D.

Filtering device 300 may include five pulleys 320—a first pulley 321, a second pulley 322, a third pulley 323, a fourth pulley 324 and a fifth pulley 325—that may be similar to first pulley 121, second pulley 122, third pulley 123, fourth pulley 124 and fifth pulley 125, respectively, described above with respect to FIGS. 1A, 1B, 1C, 1D and 1E.

Filtering mesh 330 may be threaded on, or suspended/stretched over, pulley(s) 320 and/or may envelope at least some of pulleys 320 along the entire length (or substantially along the entire length) of pulleys 320. For example, pulleys 320 and/or the locations of pulleys 320 within casing 310 may be adapted to arrange filtering mesh 300 into substantially W-shape structure (e.g., similar to W-shape structure described above with respect to FIG. 1D and FIG. 3A). Outer ends of filtering mesh 330 may form a substantially W-shape mesh curve (e.g., when filtering mesh 330 is threaded on pulley(s) 120) along which filtering mesh 330 may move when pulley(s) 320 rotate.

One of pulleys 320, for example fifth pulley 325, may be coupled to driving assembly 350 and adapted to rotate filtering mesh 330 about first pulley 321, second pulley 322, third pulley 323 and fourth pulley 324. In some embodiments, filtering mesh 330 may be enhanced at its ends with strips 336 (e.g., as shown in FIG. 4B). Strips 336 may include a plurality of openings 336a. In embodiments shown in FIG. 4B, fifth pulley 325 may include protrusions 325a at ends thereof. Protrusions 325a of fifth pulley 325 may protrude through openings 336a in strips 336 and thus enhance rotation of filtering mesh 330 by fifth pulley 325. It is noted that other pulleys 320 (rather than fifth pulley 325) may be coupled to driving assembly 350 as well.

Driving assembly 350 may include a rotational motor (not shown in FIGS. 4A, 4B and 4C for sake of clarity) coupled to one of pulley 320, e.g., fifth pulley 320, using, for example, one or more gears 354 (e.g., a bevel gear, as shown in FIG. 4C). The rotational motor may be coupled to casing 210 and on the external side thereof such that the rotational motor is isolated from water in casing 210.

In some embodiments, one or more pulleys 320 may include a stretching device 338. Stretching device 338 may be adapted to stretch filtering mesh 330 in a longitudinal direction along casing 310 (e.g., between first face 311 and second face 312 thereof). For example, each of first pulley 321 and second pulley 322 may include stretching device 338.

Advantageously, the disclosed filter device 100 may enable arranging of filtering mesh 130 into variety of shapes, according to applications of filter device 100 and/or in order to maximize the effective filtering area of filtering mesh 130 available for removal of residuals from water when filter device 100 operates in a filtering system. Furthermore, the disclosed filter device 100 may be removably mountable within a filtering system, such that it may be easily removed and replaced with another filter device 100 in the case of malfunction or routine maintenance procedures.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A filter device comprising:
a casing comprising a first face, a second face and at least one lateral face positioned between the first face and the second face and perpendicular thereto;
at least two elongated pulleys rotatably supported within the casing between the first face and the second face of the casing; and
a filtering mesh threaded on at least some of the elongated pulleys to define an interior of the filtering mesh;
wherein outer ends of the filtering mesh form, when the filtering mesh is threaded on the at least two elongated pulleys, a predetermined mesh curve along which the filtering mesh moves when the at least two elongated pulleys rotate.

2. The filter device of claim 1, further comprising a washing tube mounted within the casing and external to the interior of the filtering mesh, the washing tube extends between the first face and the second face of the casing and comprises injection apertures facing the filtering mesh through which a washing water may be injected onto the filtering mesh.

3. The filter device of claim 2, wherein the washing tube is mounted substantially adjacent to the filtering mesh such that a distance between the washing tube and the filtering mesh does not exceed 1-3 cm.

4. The filter device of claim 2, wherein a diameter of washing tube ranges between 0.8-1.2 cm, wherein a small dimension of the injection apertures ranges between 0.05-0.2 cm and wherein a distance between adjacent injection apertures ranges between 0.5-2 cm.

5. The filter device of claim 1, further comprising a drainage channel mounted within the interior of the filtering mesh and extending between the first face and the second end of the casing, the drainage channel protrudes external to the casing through a drainage opening on one of the first face or the second face of the casing.

6. The filter device of claim 5, wherein the drainage channel is mounted substantially adjacent to the filtering mesh such that a distance between a based face of the drainage channel and the filtering mesh does not exceed 4-8 cm.

7. The filter device of claim 1, further comprising a driving assembly attached to the casing and external thereto, the driving assembly is coupled to at least one of the elongated pulleys and adapted to rotate the respective at least one pulley to thereby drive and rotate the filtering mesh about the at least some of the elongated pulleys.

8. The filter device of claim 7, wherein the driving assembly comprises a rotational motor coupled to the at least one of the elongated pulleys using at least one gear.

9. The filter device of claim 1, further comprising at least one inlet opening on the first face of the casing through which water may be introduced in the interior of the filtering mesh.

10. The filter device of claim 1, wherein the at least one lateral face of the casing is a gridlike structure adapted to support the filtering mesh and to enable rotation of the filtering mesh about the at least some of the elongated pulleys.

11. A filtering system comprising:
a housing; and
a filter device removably mountable within the housing, wherein the filter device comprises:
a casing comprising a first face, a second face and at least one lateral face positioned between the first face and the second face and perpendicular thereto;
at least two elongated pulleys rotatably supported within the casing between the first face and the second face of the casing; and
a filtering mesh threaded on at least some of the elongated pulleys to define an interior of the filtering mesh;
wherein outer ends of the filtering mesh form, when the filtering mesh is threaded on the at least two elongated pulleys, a predetermined mesh curve along which the filtering mesh moves when the at least two elongated pulleys rotate.

12. The filtering system of claim 11, further comprising a washing tube mounted within the casing and external to the interior of the filtering mesh, the washing tube extends between the first face and the second face of the casing and comprises injection apertures facing the filtering mesh through which a washing water may be injected onto the filtering mesh.

13. The filtering system of claim 12, wherein the washing tube is mounted substantially adjacent to the filtering mesh such that a distance between the washing tube and the filtering mesh does not exceed 1-3 cm.

14. The filtering system of claim 12, wherein a diameter of washing tube ranges between 0.8-1.2 cm, wherein a small dimension of the injection apertures ranges between 0.05-0.2 cm and wherein a distance between adjacent injection apertures ranges between 0.5-2 cm.

15. The filtering system of claim 11, further comprising a drainage channel mounted within the interior of the filtering mesh and extending between the first face and the second end of the casing, the drainage channel protrudes external to the casing through a drainage opening on one of the first face or the second face of the casing.

16. The filtering system of claim 15, wherein the drainage channel is mounted substantially adjacent to the filtering mesh such that a distance between a based face of the drainage channel and the filtering mesh does not exceed 4-8 cm.

17. The filtering system of claim 11, further comprising a driving assembly attached to the casing and external thereto, the driving assembly is coupled to at least one of the elongated pulleys and adapted to rotate the respective at least one pulley to thereby drive and rotate the filtering mesh about the at least some of the elongated pulleys.

18. The filtering system of claim 17, wherein the driving assembly comprises a rotational motor coupled to the at least one of the elongated pulleys using at least one gear.

19. The filtering system of claim 11, further comprising at least one inlet opening on the first face of the casing through which water may be introduced in the interior of the filtering mesh.

20. The filtering system of claim 11, wherein the at least one lateral face of the casing is a gridlike structure adapted to support the filtering mesh and to enable rotation of the filtering mesh about the at least some of the elongated pulleys.
